(19) United States
(12) Patent Application Publication
(10) Pub. No.: US 2014/0010996 A1
(43) Pub. Date: Jan. 9, 2014

(54) CURING PROCESS, DECORATED ARTICLE AND METHOD FOR MANUFACTURING DECORATED ARTICLE

(71) Applicant: ETANSI INC., Taoyuan County (TW)

(72) Inventors: Chih-Che Yeh, New Taipei City (TW); Shih-Min Huang, Taipei City (TW)

(73) Assignee: ETANSI INC., Taoyuan County (TW)

(21) Appl. No.: 13/666,986

(22) Filed: Nov. 2, 2012

(30) Foreign Application Priority Data
Jul. 4, 2012 (TW) 101124059

(51) Int. Cl. B32B 37/06; B32B 38/16; B32B 15/04; B32B 3/30; B32B 7/12; B32B 38/10; B32B 33/00

(52) U.S. Cl. 428/172; 156/60; 156/281; 156/221; 156/247; 156/230; 428/195.1; 428/201; 428/209

(57) ABSTRACT

A curing process for curing a decorated article is provided. The decorated article includes a substrate, an adhesion layer and a pattern layer disposed on the substrate, sequentially. Processing conditions of the curing process include the following: a temperature ranged between 50° C. to 180° C., a relative humidity ranged between 30% to 100%, and a processing time ranged between 6 hours to 72 hours. A decorated article and a method for manufacturing the decorated article are also provided. The method for manufacturing the decorated article includes bonding a decoration film onto a substrate, and curing the decoration film and the substrate with the curing process. The decorated article is manufactured with the method for manufacturing the decorated article.

### CROSS-REFERENCE TO RELATED APPLICATION

This application claims the priority benefit of Taiwan application serial no. 101124059, filed on Jul. 4, 2012. The entirety of the above-mentioned patent application is hereby incorporated by reference herein and made a part of this specification.

### BACKGROUND

1. Field of the Invention

The invention relates to a curing process, a decorated article and a method for manufacturing the decorated article, and more particularly to, a curing process, a decorated article and a method for manufacturing the decorated article, with an enhancement of decoration film adhesion.

2. Description of Related Art

In recent years, following advances of technology industries, electronic products such as Notebook (NB), Personal Digital Assistant (PDA), Smart Phone, and so forth have frequently appeared in daily life. Types and functions of the electronic products have become increasingly diverse, and are developing towards directions of miniaturization and thinness. In addition to functional demands, appearance design has also gradually become a factor which is considered by buyers.

The electronic products may coat patterns onto a casing surface via spraying, baking paint, anodizing, or similar methods to become decorated. However, steps of the above mentioned methods are much complicated and would cause environmental pollutions. In order to solve the problems, traditional coating technologies are gradually replaced by decoration methods such as an in-mold decoration (IMD), a heat transfer printing or the likes. The decoration methods bond a decoration film with patterns onto a casing, so as to enable the casing to have different patterns.

In terms of the heat transfer printing technique, the conventional heat transfer printing technique is to bond the decoration film, which is completed in advance, on the casing to be decorated, and to apply pressure onto the decoration film, such as rolling with a roller, to integrate the decoration film closely with the casing. Although this method is simpler and more environmentally friendly than the traditional coating technologies, it can only bond the decoration film onto the casing while not able to adjust an adhesion between the decoration film and the casing. Therefore, the decoration film and the casing may have a problem of poor fitting.

### SUMMARY OF THE INVENTION

The invention provides a curing process capable of curing a decorated article to enhance an adhesion between a decoration film and a substrate.

The invention provides a method for manufacturing a decorated article capable of enhancing an adhesion between a decoration film and a substrate.

The invention provides a decorated article with a relatively high adhesion between a decoration film and a substrate thereof.

The invention provides a curing process for curing a decorated article. The decorated article includes a substrate, and an adhesion layer and a pattern layer sequentially disposed on the substrate. Processing conditions of the curing process include the following: a temperature ranged between 50° C. to 180° C., a relative humidity ranged between 30% to 100%, and a processing time ranged between 6 hours to 72 hours.

In an embodiment of the invention, the temperature is ranged between 60° C. to 90° C.

In an embodiment of the invention, the relative humidity is ranged between 70% to 95%.

In an embodiment of the invention, the processing time is ranged between 6 hours to 24 hours.

The invention further provides a method for manufacturing a decorated article including the following steps. A decoration film is bonded onto a substrate. The substrate and the decoration film are cured with the curing process.

In an embodiment of the invention, the method for manufacturing the decorated article, before bonding the decoration film onto the substrate, further includes cleaning a surface of the substrate.

In an embodiment of the invention, the method for manufacturing the decorated article, after cleaning the surface of the substrate and before bonding with the decoration film, further includes coating a primer at the surface of the substrate.

In an embodiment of the invention, the method of bonding the decoration film includes a heat transfer printing.

In an embodiment of the invention, processing conditions of the heat transfer printing are a temperature ranged between 60° C. to 180° C. and a pressure ranged between 1 kgf/cm2 to 30 kgf/cm2.

In an embodiment of the invention, the method for manufacturing the decorated article, after curing, further includes shaping the substrate.

In an embodiment of the invention, the method for manufacturing the decorated article, after curing and before shaping, further includes bonding a protective film to the decoration film.

In an embodiment of the invention, the temperature of the curing process is ranged between 60° C. to 90° C.

In an embodiment of the invention, the relative humidity of the curing process is ranged between 70% to 95%.

In an embodiment of the invention, the processing time of the curing process is ranged between 6 hours to 24 hours.

In an embodiment of the invention, the decoration film has a release layer, and the method for manufacturing the decorated article, after bonding the decoration film and before curing, further includes removing the release layer.

The invention further provides a decorated article manufactured with the above mentioned method for manufacturing the decorated article. The decorated article includes a substrate and a decoration film. The decoration film includes a pattern layer and an adhesion layer. The adhesion layer is disposed between the pattern layer and the substrate.

In an embodiment of the invention, the decorated article further includes a durable layer disposed on the pattern layer and exposed to the outside.

In an embodiment of the invention, a surface of the durable layer away from the substrate has an embossing structure.

In an embodiment of the invention, a material of the substrate is metal or plastic.

According to the foregoing, the invention provides the curing process for curing the decorated article, and the adhesion between the decoration film and the substrate is enhanced by controlling the temperature, the humidity and the processing time of the curing process. The invention further provides the method for manufacturing a decorated article, and the adhesion between the decoration film and the substrate is enhanced by curing the substrate and the decoration film with the curing process. In addition, the invention further provides the decorated article manufactured by the above mentioned method, and the adhesion between the decoration film and the substrate thereof is high.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a manufacturing flow chart of a decorated article according to an embodiment of the invention.

FIG. 2A to FIG. 2G schematically illustrate manufacturing flow diagrams of the decorated article according to the embodiment.

### DETAILED DESCRIPTION OF DISCLOSED EMBODIMENTS

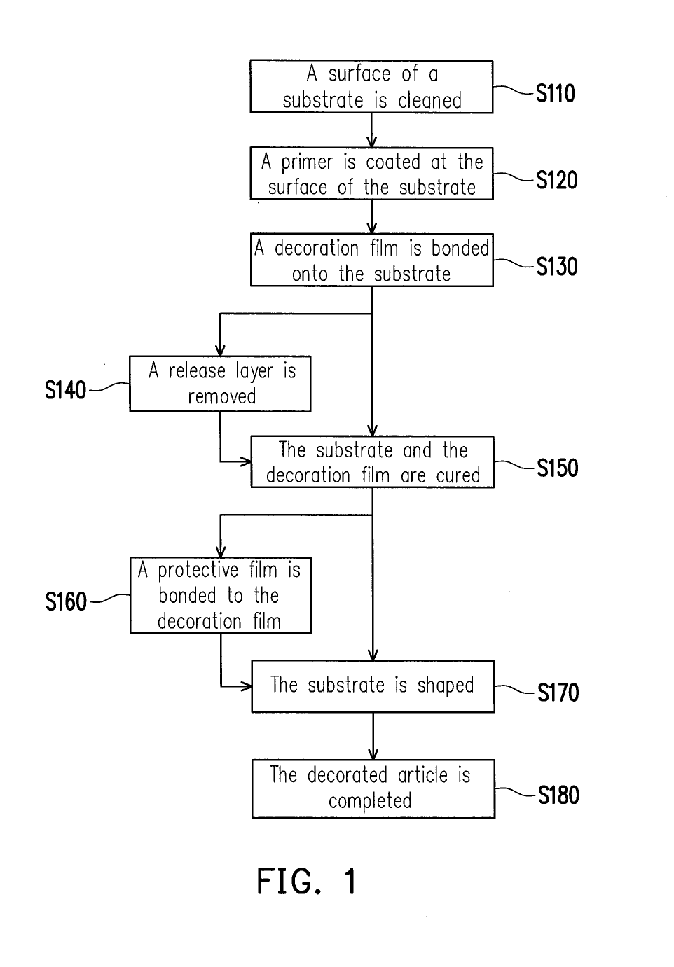

FIG. 1 schematically illustrates a manufacturing flow chart of a decorated article 100 according to an embodiment of the invention. In the present embodiment, the method for manufacturing the decorated article 100 includes the following steps. In step S110, a surface of a substrate 110 is cleaned. In step S120, a primer is coated at the surface of the substrate 110. In step S130, a decoration film 120 is bonded onto the substrate 110. In step S140, a release layer 124 is removed. In step S150, the substrate 110 and the decoration film 120 are cured. In step S160, a protective film 130 is bonded to the decoration film 120. In step S170, the substrate 110 is shaped. In step S180, the decorated article 100 is completed.

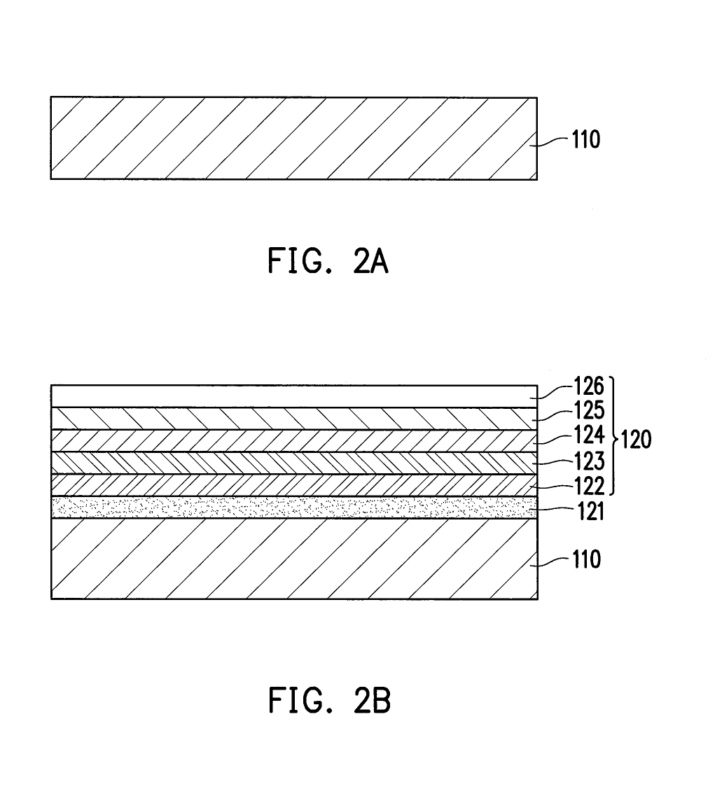

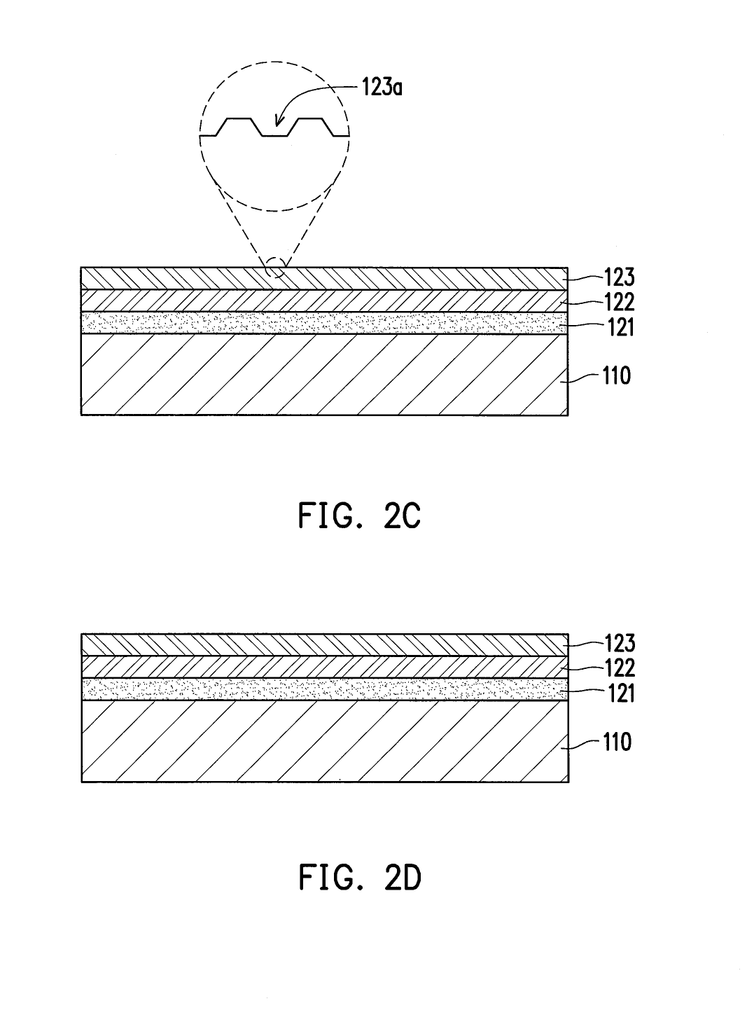

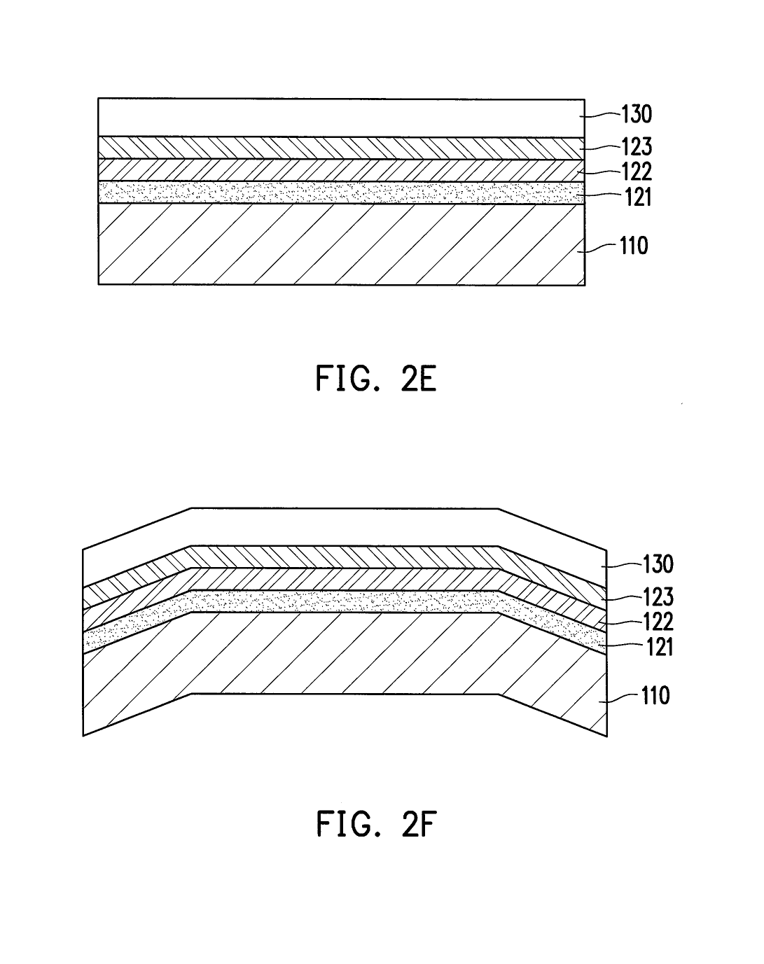

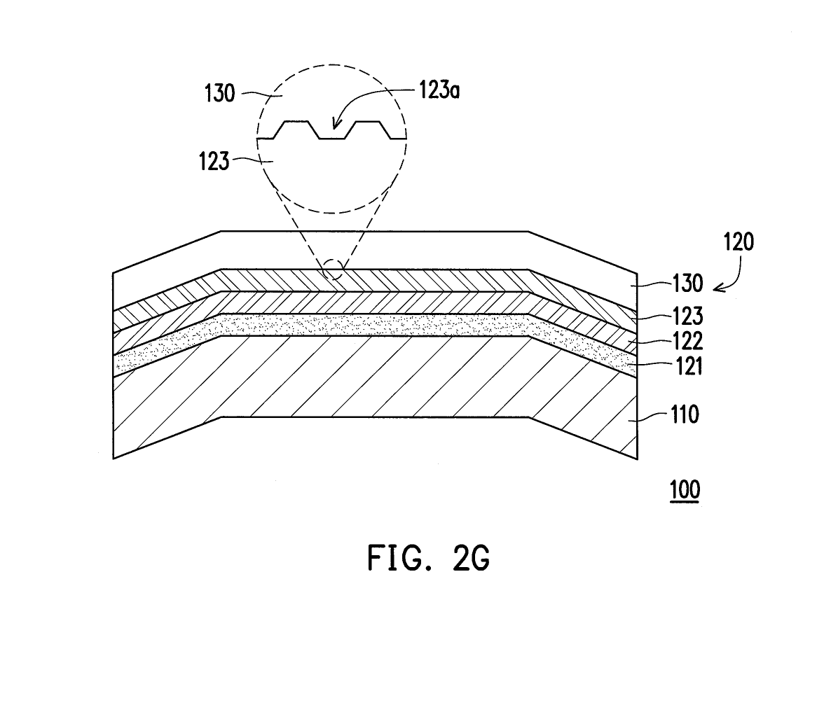

FIG. 2A to FIG. 2G schematically illustrate manufacturing flow diagrams of the decorated article according to the present embodiment. The following is to describe the method for manufacturing the decorated article 100 in detail, and in combination with FIG. 1 and FIG. 2A to FIG. 2G, sequentially.

Firstly, referring to FIG. 1 and FIG. 2A, the surface of the substrate 110 is cleaned, step S110. In the present embodiment, before bonding the decoration film 120 to the substrate 110, a pre-treatment action may be performed onto the substrate 110, for example, cleaning the surface of the substrate 110. By cleaning the surface of the substrate 110 to remove a grease, a dirt, a passivation layer or an oxide layer on the surface, so as to enable the decoration film 120 to be bonded at the surface of the substrate 110 more closely.

Next, the primer is coated at the surface of the substrate 110, step S120. In the present embodiment, the pre-treatment action of the substrate 110 may be, for example, coating the primer (not shown) at the surface of the substrate 110 after cleaning. These pre-treatment actions may be selectively performed depending on the requirement and the material of the substrate 110.

Next, referring to FIG. 1 and FIG. 2B, the decoration film 120 is bonded onto the substrate 110, step S130. In the present embodiment, the decoration film 120 includes an adhesion layer 121, a pattern layer 122, a durable layer 123, a release layer 124, a perception layer 125, and a supporting layer 126. The decoration film 120 is manufactured in advance before bonding to the substrate 110. The supporting layer 126 is used for supporting layered structures of the decoration film 120 when manufacturing the decoration film 120, and the perception layer 125, the release layer 124, the durable layer 123, the pattern layer 122, and the adhesion layer 121 are sequentially disposed on the supporting layer 126. The adhesion layer 121 is for bonding the decoration film 120 to the substrate 110. When the decoration film 120 is bonded to the substrate 110, the decoration film 120 faces the substrate 110 with the adhesion layer 121 to be bonded to the surface of the substrate 110, so that the supporting layer 126 is exposed to the outside.

In the present embodiment, the pattern layer 122 has a pattern, a color, a stripe, or the similar (not shown) capable of enhancing a visual effect of the decoration film 120. A surface of the durable layer 123 away from the substrate 110 has an embossing structure 123a (illustrated in FIG. 2C) capable of enhancing the visual or tactile effect of the decoration film 120. The perception layer 125 is for forming the embossing structure 123a on the durable layer 123. The decoration film 120 may design different patterns and structures on the pattern layer 122 and the durable layer 123 according to the requirements, so that the decorated article 100 has an appearance of diversity.

In addition, in the present embodiment, a material of the substrate 110 is metal, while in other embodiments, the material of the substrate 110 may be plastic, but the invention does not limit the material of the substrate. The decoration film 120 is, for example, bonded to the substrate 110 via a heat transfer printing technology. Processing conditions of the heat transfer printing are a temperature ranged between 60° C. to 180° C. and a pressure ranged between 1 kgf/cm2 to 30 kgf/cm2. However, the invention is not limited thereto. In other embodiments of the invention, the processing conditions of the heat transfer printing may be adjusted according to the requirements, and the decoration film 120 may be bonded to the substrate 110 via other methods.

Next, referring to FIG. 1 and FIG. 2C, the release layer 124 is removed, step S140. In the present embodiment, after the decoration film 120 is bonded to the substrate 110, the release layer 124 on the durable layer 123 may be removed, and the embossing structure 123a on the durable layer 123 are exposed to the outside and may be directly touched. In addition, main functions of the perception layer 125 and the supporting layer 126 above the release layer 124 are to form the embossing structure 123a on the durable layer 123 and to support the layered structures of the decoration film 120. Therefore, after the decoration film 120 is bonded to the substrate 110, the perception layer 125 and the supporting layer 126 may be removed together with the release layer 124.

However, in other embodiments, the release layer 124, the perception layer 125 and the supporting 126 of the decoration film 120, depending on the requirements, may choose whether to be removed, after the decorated article 100 is cured, and the invention is not limited thereto.

Next, referring to FIG. 1 and FIG. 2D, the substrate 110 and the decoration film 120 are cured, step S150. The substrate 110 and the decoration film 120 are cured with the curing process. In the present embodiment, the processing conditions of the curing process are a temperature ranged between 50° C. to 180° C., a relative humidity ranged between 30% to 100% and a processing time ranged between 6 hours to 72 hours.

On the other hand, in other embodiments of the invention, the processing condition of the curing process may be adjusted according to the requirements, for example, the temperature is ranged between 60° C. to 90° C., the relative humidity is ranged between 70% to 95%, or the processing time is ranged between 6 hours to 24 hours. By curing the substrate 110 and the decoration film 120 with the curing process, and controlling the temperature, the humidity and the processing time of the curing process, an activeness of the decoration film 120 may be enhanced during the curing process. Accordingly, the curing process may enhance the adhesion between the decoration film 120 and the substrate 110, so that the decoration film 120 and the substrate 110 have a favorable fit.

Next, referring to FIG. 1, and FIG. 2E, the protective film 130 is bonded to the decoration film 120, step S160. In the present embodiment, after using the curing process to cure the substrate 110 and the decoration film 120, the protective film 130 may be bonded to the decoration film 120. A method of bonding the protective film 130 is to attach the protective film 130 with an adhesive gel, such as a pressure-sensitive adhesive, on the decoration film 120, and to apply the pressure to enable them to bond tightly, so as to protect the embossing structure 123a exposed to the outside. However, in other embodiments of the invention, the unremoved release layer, perception layer and supporting layer may also provide a protective effect. The decorated article 100 may choose whether to use the protective film 130 according to the requirement, but the invention is not limited thereto.

Next, referring to FIG. 1 and FIG. 2F, the substrate 110 is shaped, step S170. In the present embodiment, the substrate 110 is a metal plate. After using the curing process to cure the substrate 110 and the decoration film 120, the substrate 110 may be shaped, so as to enable the substrate 110 to transform form the plate into a geometrical shape, as shown in FIG. 2F. Accordingly, the substrate 110 and the decoration film 120, which are decorated, are shaped together, so as to enable the decorated article 100 to achieve the geometrical shape of the design requirement, and also enable the decoration film 120 to tightly bond on the substrate 110 with the geometrical shape. Herein, a manufacture of the decorated article 100 is completed.

Next, referring to FIG. 1 and FIG. 2G, the decorated article 100 is completed, step 5180. After the substrate 110 and the decoration film 120 are cured and the substrate 110 is shaped, the substrate 110 and the decoration film 120 form a decorated article 100. Now, the decorated article 100 includes the substrate 110, the adhesion layer 121, the pattern layer 122, and the durable layer 123. The adhesion layer 121 is disposed between the pattern layer 122 and the substrate 110. The durable layer 123 is disposed on the pattern layer 122 and exposed to the outside. The protective film 130 may be disposed on the durable layer 123 to protect the decorated article 100. In the present embodiment, the pattern layer 122 has the pattern, the color, the stripe, and the similar (not shown), and the surface of the durable layer 123 away from the substrate 110 has the embossing structure 123a. Therefore, the decorated article 100 has the visual and the tactile effects, and may change the patterns and the structures of the pattern layer 122 and the durable layer 123 according to the requirements, so that the decorated article 100 has the appearance of diversity.

In summary, the invention provides the curing process for curing the decorated article and enhancing the activeness of the decorated film via controlling the temperature, the humidity and the processing time of the curing process, so that the adhesion between the decoration film and the substrate is higher. In addition, the invention further provides the method for manufacturing the decorated article, which bonds the decoration film manufactured in advance to the substrate, and cures the substrate and the decoration film with the curing process, so as to enhance the adhesion between the decoration film and the substrate. The invention further provides the decorated article manufactured with the method for manufacturing the decorated article, and the adhesion between the decoration film and the substrate thereof is high.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A curing process for curing a decorated article, the decorated article comprising a substrate, and an adhesion layer and a pattern layer sequentially disposed on the substrate, processing conditions of the curing process comprising:
a temperature ranged between 50° C. to 180° C.;
a relative humidity ranged between 30% to 100%; and
a processing time ranged between 6 hours to 72 hours.

2. The curing process as recited in claim 1, wherein the temperature is ranged between 60° C. to 90° C.

3. The curing process as recited in claim 1, wherein the relative humidity is ranged between 70% to 95%.

4. The curing process as recited in claim 1, wherein the processing time is ranged between 6 hours to 24 hours.

5. A method for manufacturing a decorated article comprising:
bonding a decoration film onto a substrate; and
curing the substrate and the decoration film with a curing process recited in claim 1.

6. The method for manufacturing the decorated article as recited in claim 5, wherein before bonding the decoration film onto the substrate, further comprising cleaning a surface of the substrate.

7. The method for manufacturing the decorated article as recited in claim 6, wherein after cleaning the surface of the substrate and before bonding the decoration film, further comprising coating a primer at the surface of the substrate.

8. The method for manufacturing the decorated article as recited in claim 5, wherein a method of bonding the decoration film comprises a heat transfer printing.

9. The method for manufacturing the decorated article as recited in claim 8, wherein processing conditions of the heat transfer printing are a temperature ranged between 60° C. to 180° C. and a pressure ranged between 1 kgf/cm² to 30 kgf/cm².

10. The method for manufacturing the decorated article as recited in claim 5, wherein after curing, further comprising shaping the substrate.

11. The method for manufacturing the decorated article as recited in claim 10, wherein after curing and before shaping, further comprising bonding a protective film to the decoration film.

12. The method for manufacturing the decorated article as recited in claim 5, wherein a temperature of the curing process is ranged between 60° C. to 90° C.

13. The method for manufacturing the decorated article as recited in claim 5, wherein a relative humidity of the curing process is ranged between 70% to 95%.

14. The method for manufacturing the decorated article as recited in claim 5, wherein a processing time of the curing process is ranged between 6 hours to 24 hours.

15. The method for manufacturing the decorated article as recited in claim 5, wherein the decoration film has a release layer, and after bonding the decoration film and before curing, further comprising removing the release layer.

16. A decorated article manufactured with a method for manufacturing a decorated article as recited in claim 5, the decorated article comprising:
a substrate; and
a decoration film comprising:
a pattern layer; and
an adhesion layer disposed between the pattern layer and the substrate.

17. The decorated article as recited in claim 16 further comprising a durable layer disposed on the pattern layer and exposed to the outside.

18. The decorated article as recited in claim 17, wherein a surface of the durable layer away from the substrate has an embossing structure.

19. The decorated article as recited in claim 16, wherein a material of the substrate is metal or plastic.
